(19) United States
(12) Patent Application Publication
(10) Pub. No.: US 2003/0132170 A1
(43) Pub. Date: Jul. 17, 2003

(54) River pollution management method

(75) Inventor: Wei-Guo Wu, Tainan City (CN)

Correspondence Address: BACON & THOMAS, PLLC, 625 SLATERS LANE, FOURTH FLOOR, ALEXANDRIA, VA, 22314

(73) Assignee: Wu-Hsiung WU, Tainan City (TW)

(21) Appl. No.: 10/046,254

(22) Filed: Jan. 16, 2002

(51) Int. Cl. C02F 1/00

(52) U.S. Cl. 210/747

(57) ABSTRACT

A river pollution management method comprised of a main river course and a water catchment. Each water catchment consists of an inflow mouth adjacent to seawater, an inflow gate emplaced at the inflow mouth area, a water discharge outlet located a certain distance away from the seaside outflow mouth of the main river course, and a water discharge gate emplaced at the water discharge outlet. The inflow gate at the water catchment inflow mouth is opened when the ocean tide is rising, at which time clean seawater flows into the main river course with the incoming tide and enters the water catchment where it is accumulated until the water in the main river course recedes to a certain level due to the onset of low tide. The water discharge gate at the water discharge outlet is then opened, enabling the high level of pure seawater in the water catchment to flush the turbid polluted water in main river course and evacuate it through the seaside outflow mouth.

### BACKGROUND OF THE INVENTION

1) Field of the Invention

The invention herein relates to waterway maintenance, specifically a river pollution management method in which the movement of seawater during high and low tide is utilized through controllable water catchments to purge polluted river water.

2) Description of the Related Art

Pollution has reached elevated levels due to industrial development and population density. Furthermore, many cities now under planning will discharge urban waste water directly into rivers and thereby create serious waterway contamination, especially in the final branches of the rivers approaching the sea. Since the mid- and up-stream portions are regularly drenched by rain, pollutants and turbid particulate are washed down towards the sea. However, when the lower course of river is over flat terrain, it is often difficult for turbid water from mid- and up-stream reaches to flow into the ocean, especially along the banks close to the sea. In addition, tidal forces further compound the problem because polluted water is often driven back during high tide such that standing water pollution along the mouth of rivers becomes even more concentrated. Although river maintenance involving millions of dollars in expenditures has been attempted over the years, these have been unsuccessful in effectively reducing pollution to a satisfactory degree.

### SUMMARY OF THE INVENTION

The objective of the invention herein is to provide a river pollution management method of improved capability comprised of a main river course and a water catchment, wherein each water catchment consists of an inflow mouth adjacent to seawater, an inflow gate emplaced at the inflow mouth area, a water discharge outlet located a certain distance away from the seaside outflow mouth of the main river course, and a water discharge gate emplaced at the water discharge outlet. The inflow gate at the water catchment inflow mouth is opened when the tide is rising, at which time clean seawater flows into the main river course with the incoming tide and enters the water catchment where it is accumulated until the water in the main river course recedes to a certain level due to the onset of low tide. The water discharge gate at the water discharge outlet is opened, enabling the high level of pure seawater in the water catchment to flush the turbid polluted water in main river course and evacuate it through the seaside outflow mouth.

### BRIEF DESCRIPTION OF THE DRAWINGS

Other features and advantages of the present invention will become apparent in the following detailed description of the preferred embodiments, with reference to the accompanying drawings.

FIG. 1 is a drawing of an embodiment of the invention herein during high tide.

FIG. 2 is a drawing of an embodiment of the invention herein during low tide.

FIG. 3 is a drawing of the second embodiment of the invention herein.

FIG. 4 is a drawing of the third embodiment of the invention herein.

### DETAILED DESCRIPTION OF THE PREFERRED EMBODIMENTS

In the detailed description of the preferred embodiments, it should be noted that similar elements are indicated by the same reference numerals throughout the disclosure.

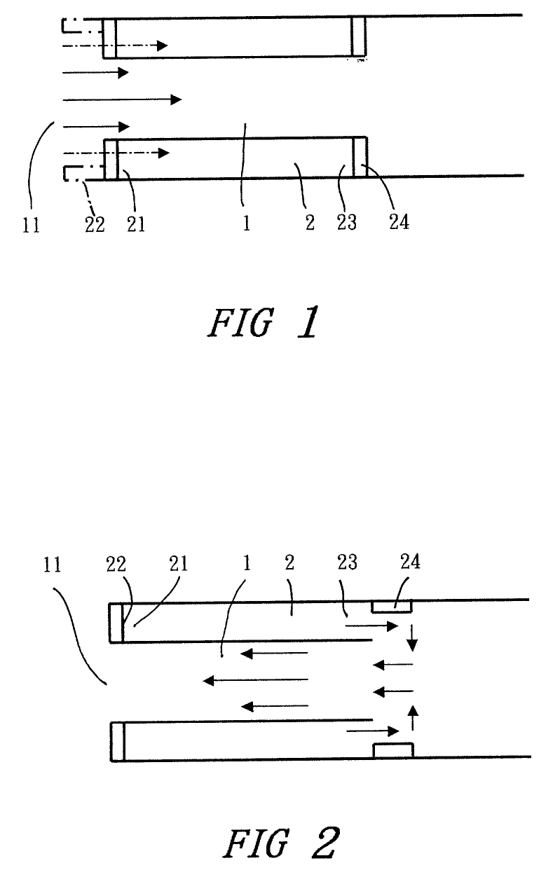

Referring to FIG. 1, the first preferred embodiment of the invention herein is comprised of a main river course 1 and a water catchment 2 in a river whose mouth is close to the sea; the said water catchment 2 is a long narrow canal built along two banks of the main river course 1 and while a plurality of water catchments 2 can be constructed according to river size and turbidity, the said embodiment has one water catchment 2 along each of the two sides of the main river course 1; each said water catchment 2 consists of an inflow mouth 21 located at a seaside outflow mouth 11 of the main river course 1 and, furthermore, adjacent to seawater, an inflow gate 22 emplaced at the inflow mouth 21 area, a water discharge outlet 23 situated a certain distance away from the seaside outflow mouth 11 of the main river course 1, and a water discharge gate 24 emplaced at the water discharge outlet 23.

To utilize, the inflow gates 22 at the water catchment 2 inflow mouths 21 are opened when the ocean tide is rising, at which time clean seawater flows into the main river course 1 with the incoming tide and enters the water catchments 2 through the inflow mouths 21 until the rising tide reaches its peak and is on the verge of declining, at which time the inflow gates 22 at the water catchment 2 inflow mouths 21 are closed and the depth of seawater accumulated in the water catchments 2 is identical to that contained in the main river course 1.

Referring to FIG. 2, water in the main river course 1 flows back into the ocean through the seaside outflow mouth 11 when the tide is ebbing, at which time the main river course 1 water level goes down and the turbid water in the main river course 1 is drawn out by the receding tide in a gradual stream through the seaside outflow mouth 11; as the main river course 1 water level is decreasing to certain depth by the action of the outgoing tide, since the water in the water catchments 2 has been maintained at the original level sourced during high tide, the water discharge gates 24 at the water discharge outlets 23 are opened, enabling the high level of pure seawater in the water catchments 2 to continue flushing the turbid polluted water in main river course 1 and discharging it through the seaside outflow mouth 11 until water in the water catchments 2 have been drained to the same level as that in the main river course 1, following which the water discharge gates 24 at the water discharge outlets 23 are closed.

As per the said principles, the respective opening and closing operation of the said inflow mouths 21 and water discharge gates 24 during high and low tide enables the continuous admittance of the pure seawater when the tide is rising and the flushing out of polluted turbid water in the main river course 1 when the tide is ebbing; since high and low ocean tides are natural phenomenon that occur daily, it is a natural means of refreshing river appearance and enables river cleansing to be undertaken every day at relatively low cost and without annual allocations of funds for maintenance and dredging which are essentially futile tasks that will eventually have to repeated.

Allowing water inflow during high tide is of course optional and does not have to be conducted every day; moreover, since the ocean in the vicinity of the seaside outflow mouth 11 may be muddy during the typhoon season, personnel in charge of the inflow mouths 21 and the water discharge gates 24 can decide according to prevailing weather and sea conditions.

The most preferred embodiment of the invention herein so presented can be modified in application arrangement to meet actual terrain and river conditions; for example, the water catchment 2 is does not have to be a low narrow channel situated in a river and can be located at selected site nearby the river, but similarly pure seawater is admitted into it during high tide and the pure seawater is drained into the river at low tide to evacuate the turbid river water.

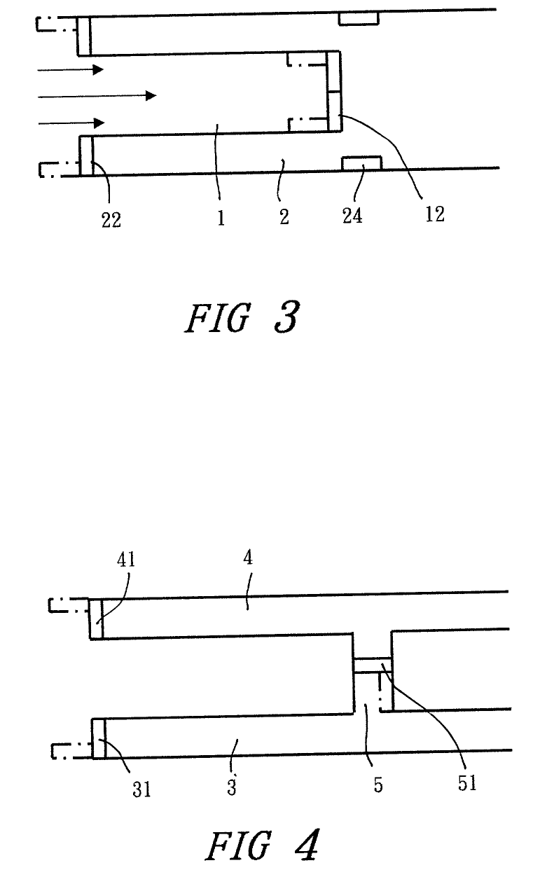

In addition to the water catchment 2 water discharge gate 24 of the first embodiment of the invention herein, the second embodiment of the invention herein shown in FIG. 3 additionally has a floodgate 12 emplaced between the water catchments 2 and the water discharge outlets 23 that enables an even larger water catchment capacity in the main river course 1 behind the floodgate 12; to deploy, the inflow gates 22 and the water discharge gates 24 of the water catchments 2 as well as the floodgate 12 are opened when the ocean tide is rising, at which time seawater is carried by the tide into the water catchments 2 and the main river course 1 until the high tide transitions to low tide, whereupon the inflow gates 22 and the floodgate 12 are closed to contain the accumulated volume in the water catchments 2 and in the main river course 1 behind the floodgate 12, which are now at the same depth; water in the main river course 1 flows back into the ocean through the seaside outflow mouth 11 as the tide is ebbing, at which time the main river course 1 water level recedes and turbid water in the main river course 1 is flushed by the outgoing tide through the seaside outflow mouth 11; when the water in the main river course 1 is reduced to a certain level by the effect of the low tide, since the water in the water catchments 2 behind the floodgate 12 is still at the high level attained during sourcing at high tide, the water discharge gates 24 and the floodgate 12 are opened, enabling the high level of pure seawater in the water catchments 2 behind the floodgate 12 to continue flushing the turbid polluted water in main river course 1 and discharging it through the seaside outflow mouth 11 until water in the water catchments 2 to the rear of the floodgate have been drained to the same level as that in the main river course 1, following which the water discharge gates 24 at the water discharge outlets 23 and the floodgate 12 are closed, with the river repeatedly cleaned based on this cyclic principle.

Furthermore, the third embodiment of the invention herein shown in FIG. 4 is an arrangement utilizing two adjacent rivers, wherein one river serves as the main river course 3, the other river serves as the water catchment 4, a channel 5 connects the two rivers at point that is a certain distance away from their seaside outflow mouths, an inflow gate 41 and 31 is respectively emplaced at the seaside outflow mouths of the said water catchment 4 and main river course 3 rivers and, and a water discharge gate 51 is disposed at the confluence between the water catchment 4 and the channel 5; the inflow gates 41 and 31 of the water catchment 4 and main river course 3 are opened when the tide is rising, at which time seawater is carried by the tide into the water catchment 4 river and the main river course 3 river until the high tide peaks and reverts to low tide, whereupon the water catchment 4 inflow gate 41 is closed and the accumulated seawater contained in the water catchment 4 river and the main river course 3 river is now at the same depth; water in the main river course 1 flows back into the ocean as the tide is ebbing, at which time the main river course 3 water level recedes and turbid water in the main river course 3 is flushed away by the outgoing tide; when the water in the main river course 3 is reduced to a certain level by the effect of the low tide, since the water in the water catchment 4 river is still at the high level attained during sourcing at high tide, the water discharge gate 51 of the channel 5 is opened, enabling the high level of pure seawater in the water catchment 4 river to continue flushing the turbid polluted water in main river course 3 and discharging it out to sea until the water in the water catchment 4 river has been drained to the same level as that in the main river course 3, following which the water discharge gate 51 is closed; based on this cyclic principle, the water catchment 4 and main river course 3 roles of the rivers can be alternated to recondition the water catchment 4 river and thereby enable the environmental management of both rivers.

1. A river pollution management method comprised of a main river course and a water catchment; each said water catchment consists of an inflow mouth adjacent to seawater, an inflow gate emplaced at the said inflow mouth area, a water discharge outlet located a certain distance away from a seaside outflow mouth of the said main river course, and a water discharge gate emplaced at the said water discharge outlet; the said inflow gate at the said water catchment inflow mouth is opened when the tide is rising, at which time clean seawater flows into the said main river course with the incoming tide and enters the said water catchment where it is accumulated until the water in the said main river course recedes to a certain level due to the onset of low tide, whereupon the said water discharge gate at the water discharge outlet is opened, enabling the high level of pure seawater in the said water catchment to flush the turbid polluted water in said main river course and evacuate it through the said seaside outflow mouth.

2. As mentioned in claim 1 of the river pollution management method of the invention herein, the said water catchment is a long narrow canal built along two banks of the said main river course.

3. As mentioned in claim 1 of the river pollution management method of the invention herein, a plurality of said water catchments can be constructed at a single installation.

4. As mentioned in claim 1 of the river pollution management method of the invention herein, a floodgate is emplaced between the said water catchments and the said water discharge outlets that enables an even larger water catchment capacity in the said main river course behind the said floodgate.

5. As mentioned in claim 1 of the river pollution management method of the invention herein, the said water catchment consists of a river.

6. As mentioned in claim 5 of the river pollution management method of the invention herein, the said water catchment is connected to the said main river course by means of an intermediary channel.

7. As mentioned in claim 5 of the river pollution management method of the invention herein, the said main river course has an inflow gate emplaced at its seaside outflow mouth.
